(19) United States
(12) Patent Application Publication
(10) Pub. No.: US 2003/0225610 A1
(43) Pub. Date: Dec. 4, 2003

(54) Method for motivating persons in a business field

(76) Inventor: Jay Bradley Doyle, Chelsea, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/158,696

(22) Filed: May 30, 2002

(51) Int. Cl. G06F 17/60

(52) U.S. Cl. 705/11

(57) ABSTRACT

A method for motivating independent business owners in which the independent business owners are divided into at least two teams, each team having a plurality of persons who are independent business owners. A plurality of business activity categories which relate favorably to success of the independent business owner in his or her business field is identified. Thereafter, the effort expended by each person on each team in each category is inputted, preferably by computer over the world wide web, at predetermined time intervals, e.g. weekly, over a predetermined time period, e.g. three months. A score is assigned to each person in each category during each time interval and these scores for each team are then tabulated over the preset time duration. The team achieving the highest win/loss record for each time interval is named the winning team and accorded appropriate recognition, prizes or the like.

### BACKGROUND OF THE INVENTION

I. Field of the Invention

The present invention relates generally to business methods and, more particularly, to a method for motivating persons in a predetermined business field, such as independent business owners.

II. Description of Related Art

Independent business owners, e.g. salespersons and business sales representatives, are a fast growing segment of the business economy within the United States for a number of reasons. For example, independent business owners not only enjoy the freedom of owning his or her own business, but also the opportunity to achieve almost unlimited financial rewards as a function of his or her success in the business field. Furthermore, independent business owners enjoy a great amount of flexibility in their working hours and working schedule so that persons with time constraints that would preclude them from a typical 9:00 a.m.-5:00 p.m. employment can still achieve success as an independent business owner.

Since independent business owners by definition work for themselves, in order to achieve financial success, it is necessary for the business owner to be self-motivated. Such self-motivation is required since the independent business owner does not have a boss or other superior to provide that motivation.

While many business owners are highly self-motivated, unfortunately others are not. Consequently, motivation techniques for these independent business owners who are not highly self-motivated is highly desirable since it would not only increase the financial and business rewards of the independent business owner, but also the business organization to which the independent business owner belongs.

### SUMMARY OF THE PRESENT INVENTION

The present invention provides a motivation technique for motivating persons in a predetermined business field, such as independent business owners.

In brief, the present invention provides a method of selecting at least two teams wherein each team has a plurality of persons, each of which is engaged in the same business field. For example, if XYZ Corporation is the manufacturer of a product sold by independent business owners or sales representatives, all of the team members would preferably be independent business representatives of XYZ Corporation. Alternatively, the teams may be composed of persons associated with different businesses.

In order to make the teams as competitive as possible, in the preferred embodiment of the present invention, individual members are ranked by their level of activity in the various categories K, preferably after such activity is weighted. Thereafter, the teams are selected, preferably by computer, such that the members on one team are as evenly ranked as possible with the members of the other teams.

A plurality of business activity categories which favorably relate to success in the business field are then identified. These categories would include, for example, attending training seminars, distributing advertising literature, reading research material, obtaining new sales accounts, etc.

Thereafter, the effort expended by each person on each team is then inputted for each category during each predetermined time period, for example weekly, over a predetermined time duration, for example three months. Preferably, this information is inputted by the team members via computer over the world wide web which is accessible, in one fashion or another, virtually worldwide. As such, team members on a given team may be geographically diverse from each other.

A score is assigned to each person in each category during each predetermined time period, i.e. weekly. In the preferred embodiment of the invention, the particular category is weighted by its importance to the business field. For example, assuming that the independent business owners are sales representatives, an activity category of obtaining a new business account would be more heavily weighted than a business activity category of reading research materials.

During each predetermined time period, the various category totals for the entire team are added together and compared with the corresponding category totals for the other teams. The team with the highest category totals for the predetermined time period is then assigned a preset count. For example, the winning team would be assigned two points for the predetermined time period, all losing teams assigned zero points and, in the event of a tie, the tying highest teams assigned one point during each predetermined time period, i.e. weekly.

At the conclusion of the predetermined time period, for example at the end of a three month period, the preset counts or weekly scores of the various teams are tabulated to determine the team with the highest total score over the entire time duration, e.g. three months. The team is so identified and appropriately rewarded through prizes, public recognition and/or the like.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a chart illustrating scoring for a single team during a single predetermined time period, i.e. weekly; and

FIG. 2 is a chart depicting team scoring over a predetermined time duration, for example three months.

### DETAILED DESCRIPTION OF A PREFERRED EMBODIMENT OF THE PRESENT INVENTION

The present invention provides a method for motivating persons, such as independent business owners, in a predetermined business field. For example, such independent business owners may be sales representatives of a predetermined company, such as XYZ Corporation, or of different businesses in a predetermined industry.

In the method of the present invention, at least two, and preferably eight or more teams are selected in which each team has a plurality of persons in the particular business field. For example, in the preferred embodiment, each team comprises ten different independent business owners while eight different teams, i.e. eighty different independent business owners, make up a particular division.

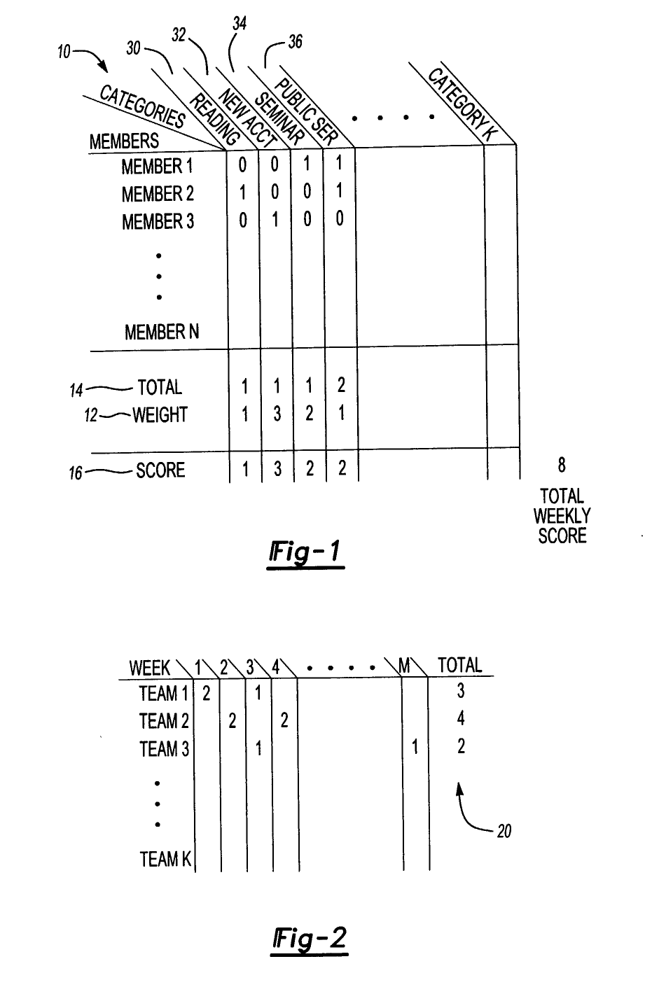

With reference now to FIG. 1, a plurality of business activity categories 10 are then identified which relate favorably to success in the particular business field. For example, the business categories are indicated at 10 in FIG. 1 such as reading 30, obtaining a new account 32, attending a seminar 34, public service 36, as well as other business activity categories. All of these business activity categories 10, furthermore, are selected to encourage participation by the individual members of the various teams. Presumably, such participation will render the individual members better and more successful independent business owners.

During each predetermined time period, for example weekly, for a predetermined time duration, such as a three month period, the individual members of the team input activity, if any, of that individual team member during the predetermined time period, i.e. during the preceding week. For example, as shown in FIG. 1, member 1 attended a seminar and engaged in activity in public service during the weekly time period. Conversely, member 2 engaged in reading as well as public service while member 3 obtained a new account during that time period.

Preferably, the entry of the effort expended by each of the members of the team during the weekly predetermined time period is inputted or entered by the individual team members by computer over the world wide web. All entries are stored by computer in the conventional fashion.

Still referring to FIG. 1, it is well recognized that certain business activity categories 10 correlate more strongly to business success than others. For example, while reading sales or scientific literature may be important, obtaining new business accounts or attending business seminars is more likely to result in a more successful business for the team members than reading. Consequently, as indicated at 12, a weight is assigned to each of the business categories 10. For example, a weight of “1” is assigned to the reading category, a weight of “3” is assigned to obtaining a new business account, a weight of “2” is assigned to attending a seminar, and so on.

Still referring to FIG. 1, the total 14 for each category 10 for each member is then multiplied by the weight 12 to obtain a total weekly score 16 for each team. The total team score 16 for all the categories is then totaled and shown as the weekly score of eight in FIG. 1. It will be understood, of course, that each team would obtain a total score for each predetermined interval, for example for each week. Furthermore, each team begins each category with a zero score at the beginning of each predetermined time period, i.e. at the start of each week, so that each predetermined time period, e.g. each week, is completely independent of each other.

With reference now to FIG. 2, the total scores for each team during each predetermined time period, i.e. the score “8” in FIG. 1, is compared for each team in each of the team divisions. One team division is illustrated as Team 1−Team N in FIG. 2. Furthermore, the team having the highest total score for the categories in a predetermined time interval 1−N is assigned two points. In the event that two teams tie for the most points, each team is allotted a single point.

For example, as shown in FIG. 2, for the first time interval one, i.e. the first week, Team 1 had the highest score and was accordingly assigned two points. For the second time interval, i.e. the second week, the second team had the highest score and was accordingly assigned two points. In the third week, i.e. the third time interval, Team 1 and Team 3 tied for the most number of points and Team 1 and Team 3 were each assigned one point.

Still referring to FIG. 2, after the expiration of the predetermined time duration, i.e. the three month time period as indicated by time interval N in FIG. 2, the total points for each team are tabulated as shown at 20. The team achieving the highest score is then rewarded by prizes, public recognition and/or the like. Optionally, the losing teams are also preferably publicized and optionally subject to negative motivation. The results of the team scoring, furthermore, are preferably publicly presented over the world wide web.

From the foregoing, it can be seen that the present invention provides a novel method for motivating persons, such as independent business owners, in a predetermined business field. The method of the present invention not only takes into account the various business activities necessary for success in the business field, and motivates the members of the various teams to engage in these diverse activities.

The present invention is further advantageous in that it recognizes the different importance of the various business activities by assigning different weights to these different business activities. The assignment of the different weight values, furthermore, encourages the various team members to engage in those activities having the highest weight and thus the highest potential score.

Having described my invention, however, many modifications will become apparent to those skilled in the art to which it pertains without deviation from the spirit of the invention as defined by the scope of the appended claims.

I claim:

1. A method for motivating persons in a predetermined business field comprising the steps of:
selecting at least two teams, each team having a plurality of persons each of which is engaged in the business field,
identifying a plurality of business activity categories which relate favorably to success in the business field,
inputting effort expended by each person on each team in each activity category at predetermined time intervals over a predetermined time duration,
assigning a score to each person in each category during each time interval,
tabulating the assigned scores in each category for each team over said time duration, and
naming a winning team as a result of said tabulation.

2. The invention as defined in claim 1 wherein said tabulating step further comprises the steps of:
totaling the effort expended by each person in each team in each category during each predetermined time interval into a category total,
assigning a preset count to the team having the highest category total in each category during each predetermined time interval,
adding said preset counts for each team in all categories together during each predetermined time interval to obtain an interval total for each team,
assigning a preset time interval score each predetermined time interval to the team having the highest interval total,
totaling the time interval scores over said time duration.

3. The invention as defined in claim 2 wherein the step of assigning a preset count further comprises the step of assigning a preset weighted count as a function of the activity category.

4. The invention as defined in claim 1 wherein the business field comprises independent business owners.

5. The invention as defined in claim 2 wherein said assigning a preset time interval score step further comprises the step of assigning one half of the preset time interval score to each team having the highest category total in each category during each predetermined time interval in the event of a tie.

6. The invention as defined in claim 1 wherein each team comprises ten persons.

7. The invention as defined in claim 1 and comprising the step of ranking each person as a function of the category scores over said time duration, and selecting persons for each team that are substantially evenly matched in ranking.

8. The invention as defined in claim 1 wherein said inputting step comprises the step of inputting data by computer via the world wide web.
